(19) United States
(12) Patent Application Publication
(10) Pub. No.: US 2007/0027830 A1
(43) Pub. Date: Feb. 1, 2007

(54) Dynamic content development based on user feedback

(75) Inventors: Nicholas M. Simons, Redmond, WA (US); Christopher J. Brown, Redmond, WA (US); Gregory F. Koehler, Seattle, WA (US); Nancy E. Jacobs, Redmond, WA (US); Robert N. Ashby, Renton, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/193,025

(22) Filed: Jul. 29, 2005

(51) Int. Cl. G06F 17/30

(52) U.S. Cl. 707/1

(57) ABSTRACT

A user may provide feedback about content to express satisfaction or dissatisfaction with an application. Data associated with the user's location, the feedback, and the content is processed to provide a content author with information about how the content may be improved to increase customer satisfaction. The content author reviews the information and may modify the content or develop new content based on the information.

### BACKGROUND

Many software programs ship with electronic documentation such as an instruction manual integrated into the program. The documentation may be summoned by utilizing a help command when a user encounters a problem while running the program. The program may display a menu of help topics when the help system is accessed. The user may choose the appropriate topic for the problem encountered. The program then displays a help screen that contains the desired documentation. The assistance provided by a help command may not adequately address a problem because the information provided by the help function is often static with respect to the program.

A content developer may rely on user feedback to an application to determine how program documentation may be improved for subsequent release. However, in some cases a content developer may not have easy access to feedback stores and in other cases the content developer is unable to necessitate any content changes because the content is static. In other cases, user feedback is collected in a database. A content developer is required to mine the database for the user feedback. Data mining presents such a barrier to usability that the user feedback is rarely acted upon.

### SUMMARY

The present disclosure is directed to the dynamic development of content based on user feedback. A user executes an action to access content from an application. The server executes the action and returns the content to the client. The user reviews the content. The user submits feedback about the content to the server. The server processes the feedback, action and content to generate information that informs a content author how the content may be improved to increase customer satisfaction. The content author may also be provided with information regarding content usage or product location. The content may be prioritized based on corresponding user feedback such that the content author may determine which content requires the most improvement. The content author may be presented with content that is frequently accessed and has a low user satisfaction rating. The content author may then modify the content or develop new content in an effort to increase user satisfaction. After the updated content is posted to the server, subsequent users may access the updated content and provide additional feedback. The content author may determine whether user satisfaction has improved based on the additional feedback. The content author may remodify the content to further improve user satisfaction.

The above summary of the present disclosure is not intended to describe every implementation of the present disclosure. The figures and the detailed description that follow more particularly exemplify these implementations.

### BRIEF DESCRIPTION OF THE DRAWINGS

FIG. 1 is a functional diagram illustrating a computing environment that may be used in one aspect of the present invention.

FIG. 2 is a functional diagram illustrating a system for dynamically developing content based on user feedback, in accordance with one aspect of the invention.

FIG. 3 is a screenshot illustrating an example interface that is presented to a user for inputting feedback about content, in accordance with one aspect of the invention.

FIG. 4 is a screenshot illustrating an example interface that is presented to a user for inputting feedback about content.

FIG. 5 is a screenshot illustrating an example feedback table, in accordance with one aspect of the invention.

FIG. 6 is a screenshot illustrating an example query table, in accordance with one aspect of the invention.

FIG. 7 is a screenshot illustrating an example aggregate data table, in accordance with one aspect of the invention.

FIG. 8 is a screenshot illustrating an example interface including modified content, in accordance with one aspect of the invention.

FIG. 9 is a screenshot illustrating an example aggregate data table, in accordance with one aspect of the invention.

FIG. 10 is an operational flow diagram illustrating a process for dynamically developing content based on user feedback, in accordance with one aspect of the invention.

### DETAILED DESCRIPTION

The present disclosure is directed to the dynamic development of content based on user feedback. A user may provide feedback about content (e.g., on a web site) to express satisfaction or dissatisfaction with an application. Data associated with the user's location, the feedback, and the content is processed to provide a content author with information regarding the content. The content author reviews the information and may modify the content or develop new content based on the information. The present disclosure provides content authors with a tool for creating useful, compelling content, and building successful web sites. The tool may also be used to improve content development methodology by enabling a content author to compare user satisfaction ratings of different content.

For example, a user may not be able to determine how to blind carbon copy (“Bcc”) a recipient on an e-mail message. The user accesses a help function in the email application for more information. The user initiates a query with the search terms “How to use Bcc.” A number of help topics are returned. The user selects and reviews a help topic, but the help topic does not address the user's issue. The user provides feedback including a rating and/or a comment that identifies the shortcomings of the help topic. The feedback, the query, and other information associated with the content are submitted to a server. The server processes and stores the information for analysis and review by a content author.

The content author assigned to the Bcc help topic may review the feedback associated with the content and determine that the help topic received dissatisfactory user feedback. The content author may then investigate the issue. The investigation may involve determining user location in the application when the feedback was provided. The content author may also review the ratings and comments provided by users. The content author may then modify the content or develop new content based on user location and feedback. The modified/developed content is posted to the server. The content author may subsequently evaluate feedback associated with the posted content to determine whether further modifications or new developments are necessary to improve user satisfaction.

Embodiments of the present disclosure now will be described more fully hereinafter with reference to the accompanying drawings, which form a part hereof, and which show, by way of illustration, specific exemplary embodiments for practicing the invention. This disclosure may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present disclosure may be embodied as methods or devices. Accordingly, the present disclosure may take the form of an entirely hardware embodiment, an entirely software embodiment or an embodiment combining software and hardware aspects. The following detailed description is, therefore, not to be taken in a limiting sense.

Illustrative Operating Environment

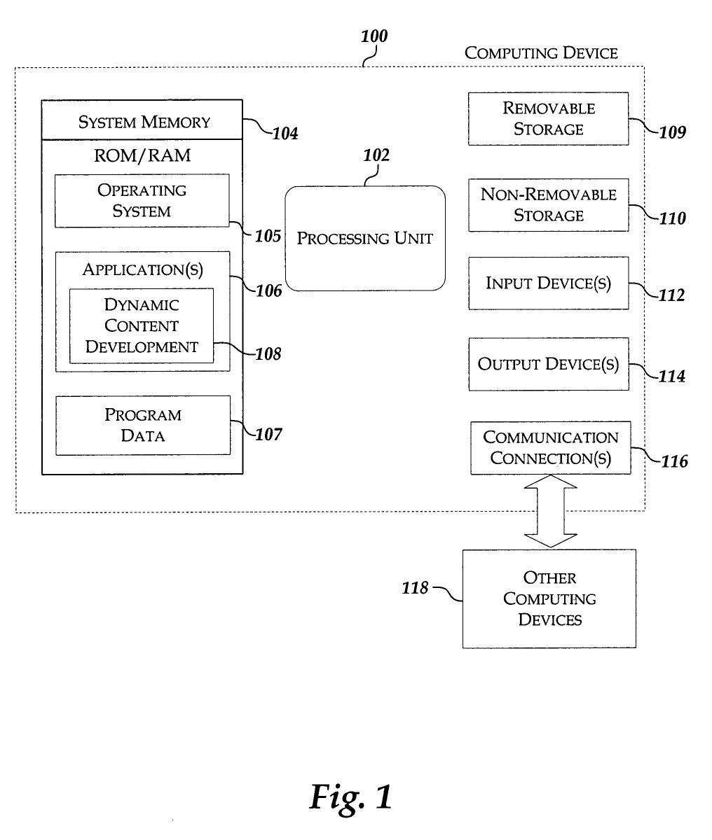

Referring to FIG. 1, an exemplary system for implementing the invention includes a computing device, such as computing device 100. Computing device 100 may be configured as a client, a server, a mobile device, or any other computing or consumer electronic device that interacts with data in a network based collaboration system. In a very basic configuration, computing device 100 typically includes at least one processing unit 102 and system memory 104. Depending on the exact configuration and type of computing device, system memory 104 may be volatile (such as RAM), non-volatile (such as ROM, flash memory, etc.) or some combination of the two. System memory 104 typically includes an operating system 105, one or more applications 106, and may include program data 107. Applications 106 include dynamic content development application 108 which is described in detail below.

Computing device 100 may have additional features or functionality. For example, computing device 100 may also include additional data storage devices (removable and/or non-removable) such as, for example, magnetic disks, optical disks, or tape. Such additional storage is illustrated in FIG. 1 by removable storage 109 and non-removable storage 110. Computer storage media may include volatile and nonvolatile, removable and non-removable media implemented in any method or technology for storage of information, such as computer readable instructions, data structures, program modules, or other data. System memory 104, removable storage 109 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of device 100. Computing device 100 may also have input device(s) 112 such as keyboard, mouse, pen, voice input device, touch input device, etc. Output device(s) 114 such as a display, speakers, printer, etc. may also be included.

Computing device 100 also contains communication connections 116 that allow the device to communicate with other computing devices 118. For example, communication connections 116 include ultra wideband network interface card 117 which enables ultra wideband wireless communication with other computing devices 118. Communication may occur over a network. Networks include local area networks and wide area networks, as well as other large scale networks including, but not limited to, intranets and extranets. Communication connection 116 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

Dynamic Content Development Based on User Feedback

The present disclosure is described in the general context of computer-executable instructions or components, such as software modules, being executed on a computing device. Generally, software modules include routines, programs, objects, components, data structures, and the like that perform particular tasks or implement particular abstract data types. Although described here in terms of computer-executable instructions or components, the invention may equally be implemented using programmatic mechanisms other than software, such as firmware or special purpose logic circuits.

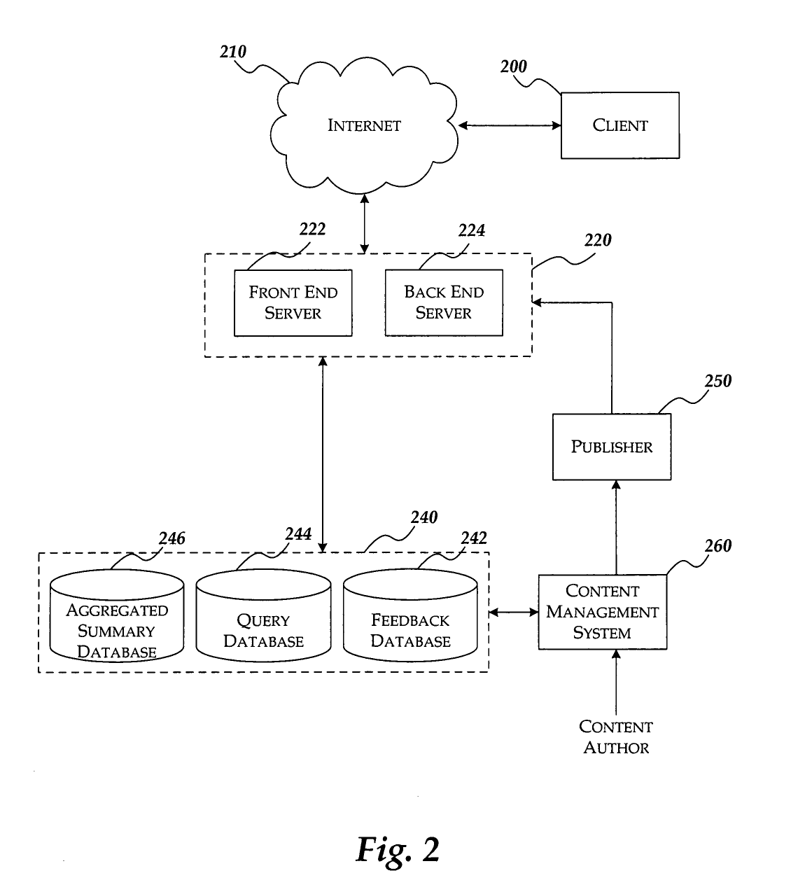

FIG. 2 is a functional diagram illustrating a system for dynamically developing content based on user feedback. The system includes client 200, internet 210, server 220, data store 240, publisher 250, and content management system 260. Client 200 is coupled to server 220 via internet 210. Server 220 is coupled to data store 240 and publisher 250. Content management system 260 is coupled to data store 240 and publisher 250. A content author may access content management system 260 either directly or via a network to review and modify content and information associated with content. Server 220 may include front end server 222 and back end server 224. Data store 240 includes feedback database 242, query database 244, and aggregated summary database 246.

A user at client 200 may initiate an action to access content. The content may be associated with any aspect of an application. The user may attempt to access the content from different entry points. For example, the user may access the content by browsing through categories on a web site, clicking a link on a web page, clicking a link included in an email message, clicking a link in the application, or searching for the content via a search engine.

In one embodiment, the content is associated with a help topic in an application. The help function may provide assistance to the user via a network such as the internet. For example, the user may seek more information associated with a Bcc function in an email application by selecting search terms (e.g., “bcc”) in a help topic window. Client 200 may submit a query using the search terms to server 220 via internet 210. Server 220 executes the search and responds to client 200 with a list of search results. For example, the search results may include a list of help topics related to the Bcc function. The user may then select one of the search results such that content associated with the selected search result is downloaded to client 200. The search result may be selected from a menu, web form, topic index, etc.

The user reviews the content associated with the selected search result that is downloaded from server 220. The user may then submit feedback associated with the reviewed content to server 220. For example, the user provides a rating and a comment based on whether the help information provided for the Bcc function was helpful. User feedback may be collected through a number of different feedback entry locations in an application or from a website associated with an application. The feedback is posted to server 220 for logging. The logged feedback entry may include the selected search result, the feedback, and a time stamp.

Feedback database 242 stores the rating and comment information submitted by the user. The rating and comment information is associated with the content. Query database 244 stores information related to a usage pattern. For example, the search terms (e.g., “bcc”) submitted by the user may be stored in query database 244. In another example, information associated with the page where the content was accessed may also be stored in query database 244. The information may include a previous page, the query that contained a search result that the user clicked on, the location of the user within the application, the type of link that the user clicked, and the time when the user accessed the content. The actual accessed content (e.g., the Bcc help topic) may also be stored in query database 244.

A server process aggregates data associated with the content, query, ratings and comments. The aggregated data is stored in aggregated summary database 246. Aggregated summary database 246 may prioritize the content and corresponding feedback such that the content author may address issues regarding poorly rated content. Thus, the content author is not required to manually determine which content might require modification, e.g., by mining data store 240.

The content author may access content management system 260 either directly or via a network. Content management system 260 enables the content author to access data store 240. Thus, the content author may access feedback information, query information, and aggregated summary information. The content author may determine that content may require modification or that new content should be developed based on the accessed information. The content author may modify/develop content and submit the updated content to publisher 250. Publisher 250 then posts the modified content to server 220 to update the content. Thus, the next time that client 200 accesses the content from server 220, the updated content is accessed. Subsequent feedback about the updated content may be received from other users who access the published content. The content author evaluates the content and the corresponding feedback to determine whether the issue is to be closed or is to remain open until customer satisfaction regarding the content or an underlying feature improves.

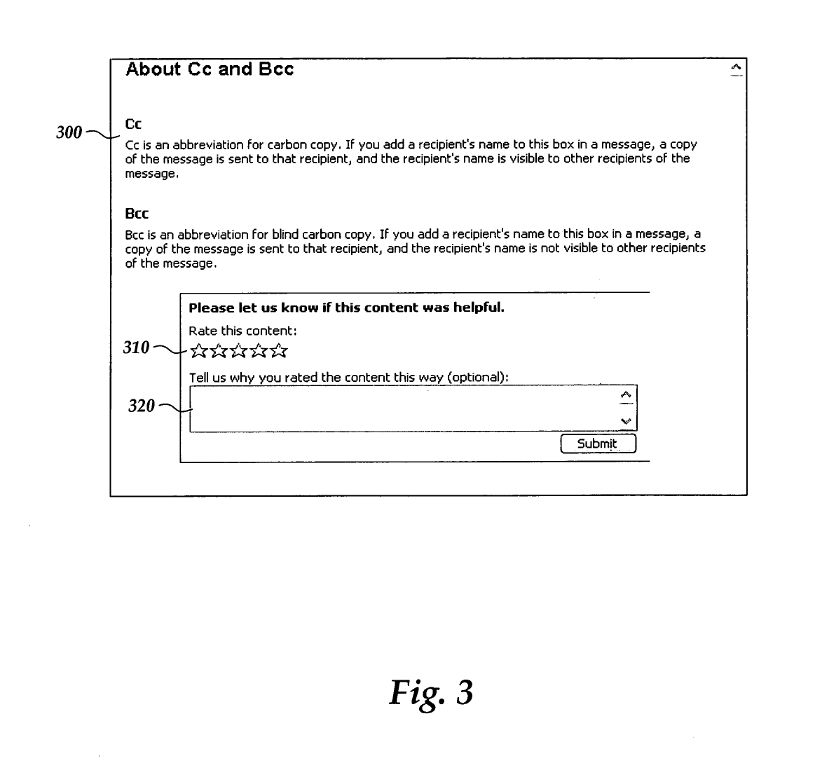

FIG. 3 is a screenshot illustrating an example interface that is presented to a user for inputting feedback about content. The interface may be presented when the user selects a search result while the user is running an application or navigating a web page on the Internet. For example, the user may select a help topic from a list of search results. The interface includes content 300, rating input 310, and comment box 320. Content 300 includes the information sought by the user. The user reviews content 300. The user may then enter rating input 310 to indicate content satisfaction. As shown in the figure, the rating may be a star system where a user selects up to five stars, one star corresponding to extreme dissatisfaction and five stars corresponding to extreme satisfaction. It is understood that other rating systems may be used without departing from the scope of the invention.

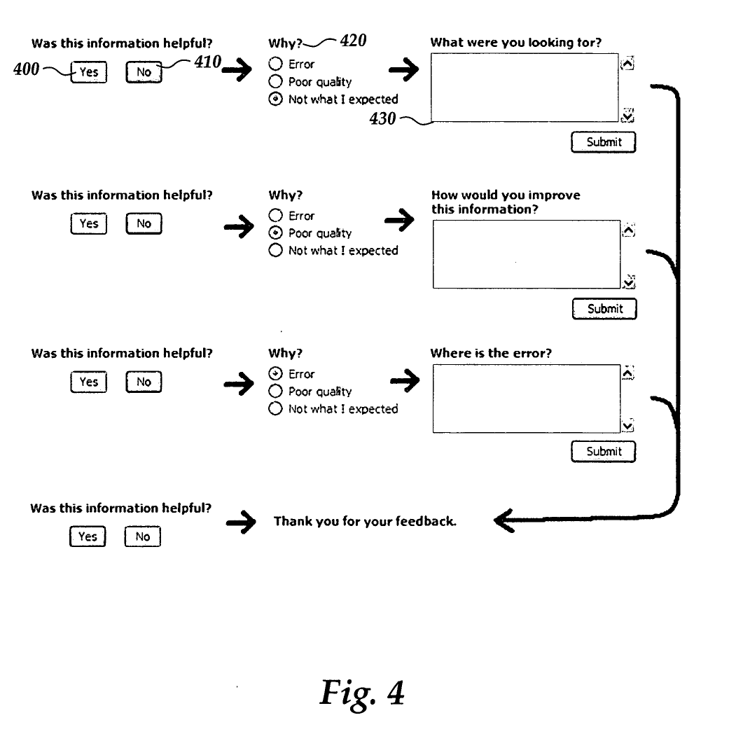

FIG. 4 is a screenshot illustrating an example interface that is presented to a user for inputting feedback about content. The interface may prompt the user with “Was this information helpful?” The user may then select a “yes” and “no” buttons 400, 410 to rate the content. In another embodiment, the user may also be presented with “maybe” and “don't know” buttons to rate the content. If the user selects “yes” button 400, then the user is satisfied with the content. The interface may display “Thank you for your feedback.” to the user.

If the user selects “no” button 410 because the content was not helpful, the interface may present the user with “Why?” menu 420 that includes a list of reasons for why the content may not have been helpful. For example, the list of reasons may include “Error”, “Poor quality”, and “Not what I expected”. The user selects a reason from the list of reasons. The interface then displays comment box 430 for the user to further elaborate on the selected reason. The interface may also prompt the user based on the selected reason. For example, if the user selected the “Not what I expected” reason from the list of reasons, the interface may display “What were you looking for?” above comment box 430. Thus, the interface suggests to the user the type of comments that should be entered in comment box 430. User comments provide the content author with specific feedback such that the content may be modified or new content may be developed in accordance with user needs.

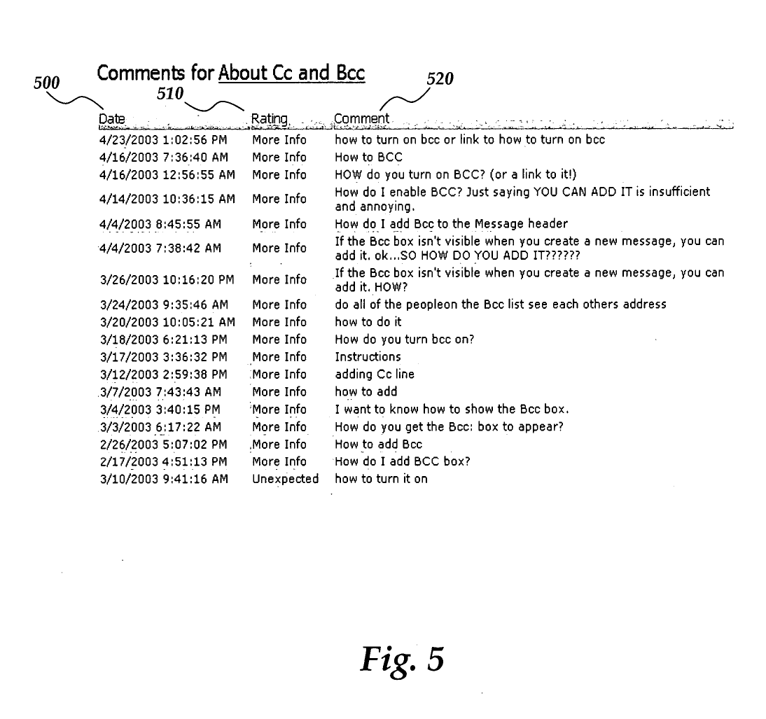

FIG. 5 is a screenshot illustrating an example feedback table that includes information associated with content. For example, the feedback table may include user feedback describing the user's experience while running an application or navigating a web site. As shown in the figure, the feedback table includes information associated with an “About Cc and Bcc” help topic. The feedback table includes columns for date 500, rating 510, and comment 520. Entries in the date column refer to time stamps that identify when a user submitted feedback for the content. Entries in the rating column correspond to the actual content ratings submitted by a user. Entries in the comment column list the text of the comment. The information in the comment column enables content authors and site managers to identify issues associated with specific content. Other columns may be added to the feedback table without departing from the scope of the invention. For example, a column identifying information related to a user's program location within the application when the content was accessed may be included in the feedback table.

The content author may access the feedback table associated with the content to determine why users might be dissatisfied with the content. For example, the content author may determine from the rating column that the content is missing information sought by users. The content author may also determine from the comment column that most users were dissatisfied with the content because the “About Cc and Bcc” help topic does not include information about how to add a Bcc line in an email message.

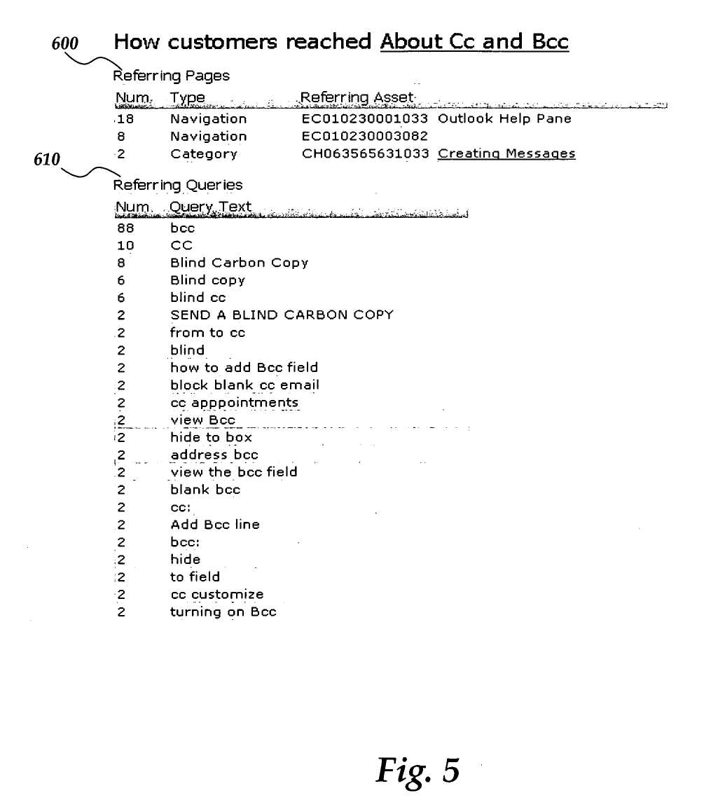

FIG. 6 is a screenshot illustrating an example query table that includes information related to how users accessed the content. The information includes referring pages 600 and referring queries 610. Referring pages 600 identify the location (e.g., web page) from which the user requested the content. The content author may determine the location in an application that includes problem areas based on referring pages 600. As shown in the query table, most users accessed the “About Cc and Bcc” help topic from a location called “Outlook Help Pane”. Referring queries 610 includes the search terms that the user entered to locate the content. The content author may determine the subject of the user's issue based on referring queries 610. As shown in the query table, the most popular search terms are “bcc”. The content author may further utilize referring queries 610 to improve the relevancy of a search engine.

The content author or site manager may use the information in the query table to identify usage patterns associated with the content. The usage patterns may direct the content author to problem areas in an application. For example, the content author may recognize that most users who accessed “About Cc and Bcc” entered the “bcc” search terms from the “Outlook Help Pane”. Thus, the content author may determine that there is a problem with the Bcc help topic in the “Outlook” email application.

Other information may be added to the query table without departing from the scope of the invention. Examples of other information that may be included in the query table include: the content author, an application associated with the content, the type of content, and an asset for a specific location or market.

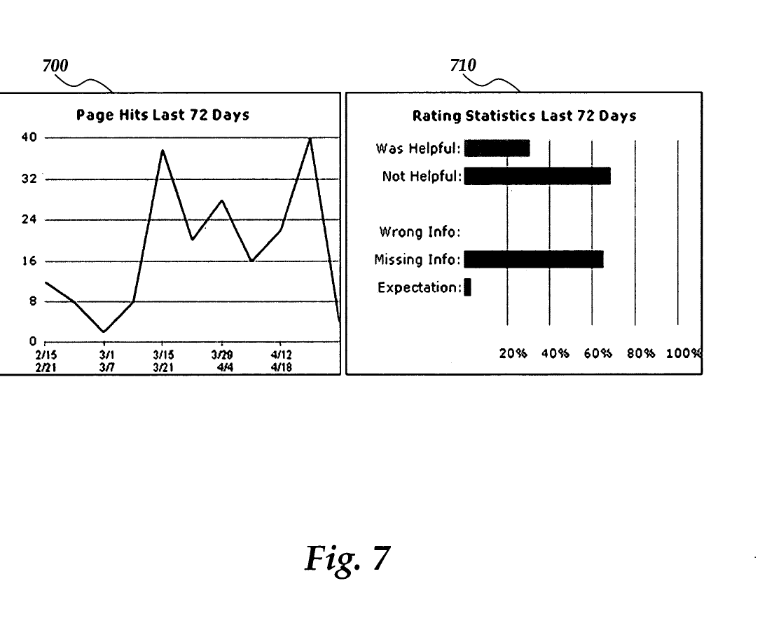

FIG. 7 is a screenshot illustrating an example aggregate data table that includes information related to content usage. The aggregate data table includes line graph 700 that identifies how often the content was accessed over a period of time. The information provided by line graph 700 may be used to determine whether enough users accessed the content such that the feedback may be relied on to accurately improve the content. The aggregate data table also includes bar graph 710 that identifies rating statistics based on feedback provided over a period of time.

The content author reviews the aggregate data table of all assets of a certain type, such as the assets owned by the content author. The automatic ranking of poorly performing content prompts the content author to examine the results of specific content. The content author discovers the specifics of the aggregate data table relating to specific content, such as individual ratings, comments, queries, and usage patterns.

As shown in bar graph 710, more than 65% of all users who accessed the content did not find the content to be helpful. Further referring to bar graph 710, the reason that most users were dissatisfied is because the sought after information is missing from the content. The content author may determine from the rating statistics and the number of page hits that the content needs to be modified to include the missing information. For example, the content author may modify the “About Cc and Bcc” help topic to include a link to the help topic that provides instruction about how to add a Bcc line to an email message.

In one embodiment, the aggregate data table is provided to the content author when a determination is made that a predetermined percentage of feedback indicates user dissatisfaction. In another embodiment, an aggregate data list identifies and prioritizes frequently viewed content with a high user dissatisfaction rating. The content may be prioritized by associating a priority value with the content. The priority value may be calculated by the product of a content's dissatisfaction rating percentage and the number of content page views.

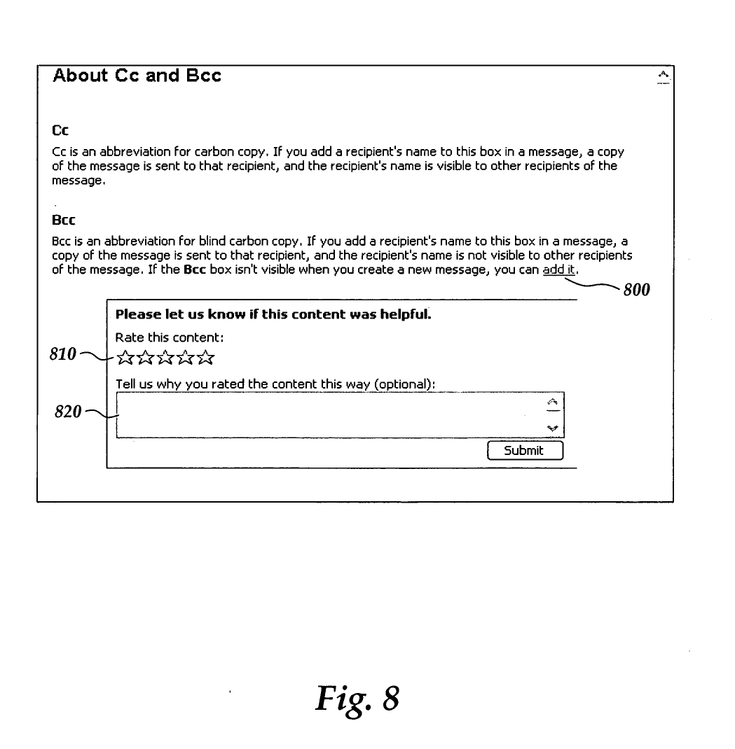

FIG. 8 is a screenshot illustrating an example interface including modified content that is presented to the user when the user selects a search result. For example, the user my select the “About Cc and Bcc” help topic from a search result list. The interface is presented to the user with the updated content provided by the content author. The updated content includes link 800. Link 800 directs a user to instructions about how to add a Bcc line to an email message. After viewing the content, the user may enter rating input 810 based on the user's satisfaction with the content. The user may also enter a comment in comment box 820 to elaborate on the rating.

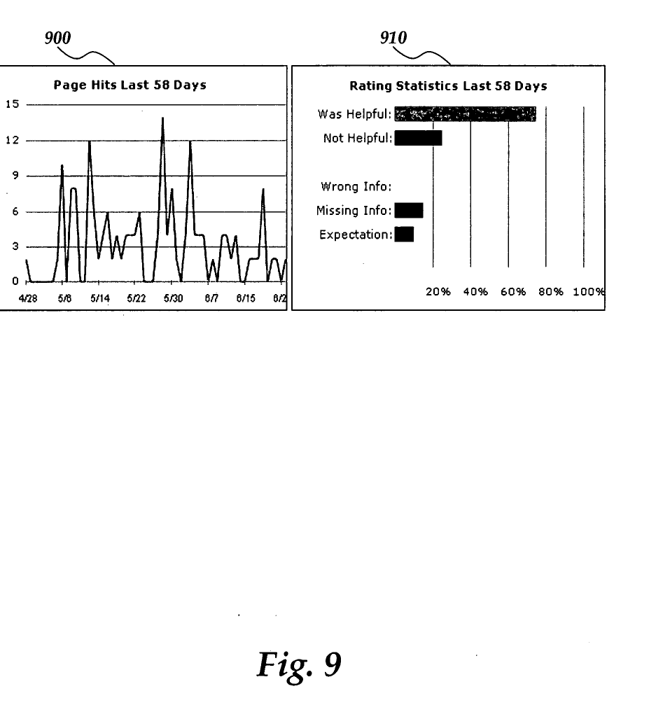

FIG. 9 is a screenshot illustrating an example aggregate data table that includes information related to content usage. After a period of time has passed since the modified content was published, the aggregate data table may be accessed to determine whether user satisfaction with the modified content has improved. The aggregate data table includes line graph 900 that identifies how often the content was accessed over a period of time. The aggregate data table also includes bar graph 910 that identifies rating statistics provided by users over a period of time. As shown in the aggregate data table, more than 70% of all users who accessed the content since the content author modified the content found the content to be helpful. Thus, the content modification greatly improved user satisfaction. The content author may remodify the content based on subsequent feedback, and then republish the content if a higher satisfaction rating is desired.

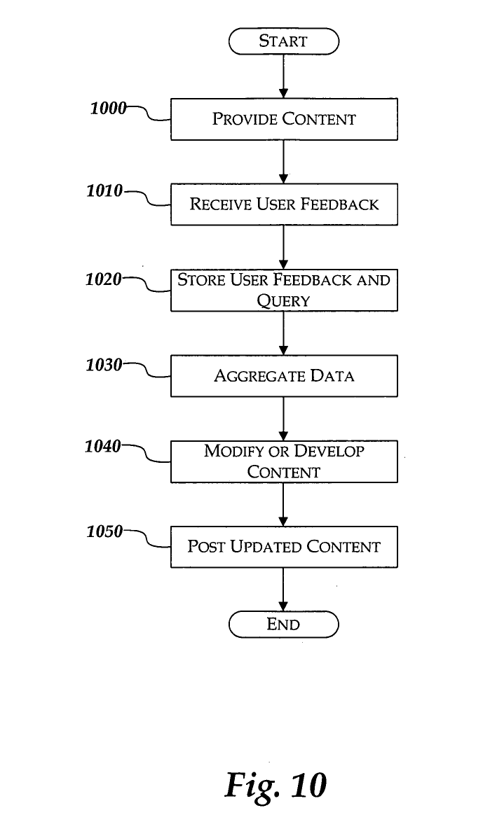

FIG. 10 is an operational flow diagram illustrating a process for dynamically developing content based on user feedback. The process begins at a start block where a user initiates an action to access content. The content may be associated with any aspect of an application. The user may attempt to access the content from different entry points. For example, the user may access the content by browsing through categories on a web site, clicking a link on a web page, clicking a link included in an email message, clicking a link in the application, or searching for the content via a search engine. In one embodiment, the content is associated with a web-based help system of an application. The user may initiate a search by entering search terms in a search engine associated with a web site. A query based on the search terms may be submitted by the user from a client to a server via a network, such as the Internet.

At block 1000, the server provides the content to the client. For example, the user is navigated to a web page associated with a link that the user clicked. In another example, the server may parse the search terms from the query. Content associated with the search terms is located. The content may be located on the server or in a data store coupled to the server. The server provides search results to the client via the network. The search results may provide the user with the desired content at the client. Alternatively, the search results may be a list of different content associated with the search terms such that the user may select the desired content from the list. The desired content is downloaded to the client in response to user selection. The user may then review the content at the client.

Proceeding to block 1010, the server receives user feedback about the content. The feedback may include a rating and a comment. The user selects a rating to identify the level of satisfaction with the content. For example, the content my include the prompt, “Was this information helpful?” followed by a five star rating system. The user may indicate the helpfulness of the information by entering up to five stars to indicate the level of user satisfaction. The user may also enter a comment in a comment box presented with the content to further elaborate on the rating. A user may be more likely to comment on the content when the user is dissatisfied with the information provided. Thus, the comments are useful to a content author seeking to improve user satisfaction. The server then logs the query, the received feedback and the associated content.

Moving to block 1020, the received feedback and information associated with the query are stored in a data store coupled to the server. The feedback including the rating and the comment may be stored in a feedback database. The query information including the search terms may be stored in a query database. The selected content resulting from the query may also be stored in the query database.

Transitioning to block 1030, the server aggregates data using the feedback, the query information, and the content. The aggregated data provides information to the content author such that the content author may determine how to improve the level of user satisfaction associated with the content. For example, the aggregated data may include a comment table that identifies the content and lists ratings and comments associated with the content. The comment table may also include a time stamp that identifies when the feedback was submitted. In another example, the aggregated data may include a query table that identifies information about how users accessed the content. The information may include the location in the application from which the user accessed the content, and search terms entered by the user to locate the content. In yet another example, the aggregated data may include a content table that identifies information associated with content usage. The information may include the number of hits the content received over a period of time. The information may also include the percentage of users who were satisfied/dissatisfied with the content. The information may further include data relating to reasons for user dissatisfaction. The aggregated data may be stored in an aggregated summary database in the data store.

Continuing to block 1040, the content author modifies the content based on the aggregated data, the query, the feedback, and/or the content. A content management system provides access to the data store. The content author may access the content management system via a network. The content author reviews the aggregated data, the query, and the feedback associated with the content to be modified. The content management system enables the content author to modify the content or develop new content, and store the modified/developed content in the data store. The content management system then forwards the updated content to a publisher. The publisher posts the updated content to the server at block 1050.

A user may then access the content from the server. The server provides the user with the content that has been updated in light of user feedback. The user may then submit additional feedback. The content author may remodify the content or further develop new content based on the user feedback. The process may continue until the content author determines that the content receives a satisfactory rating. Processing then terminates at an end block.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A computer-implemented method for dynamically developing content, comprising:
locating the content based on an action to access the content;
receiving feedback associated with the content, wherein the feedback indicates a level of user satisfaction associated with the content;
aggregating data based on at least one of: the action, the feedback, and the content, wherein the aggregated data indicates how the content may be modified to increase the level of user satisfaction associated with the content;
modifying the content based on the aggregated data; and
posting the modified content.

2. The computer-implemented method of claim 1, further comprising determining a location from which the query was submitted, and wherein aggregating data further comprises aggregating data based on the location to identify a usage pattern associated with the content.

3. The computer-implemented method of claim 1, wherein the action is a query comprising search terms, and wherein aggregating data further comprises aggregating data based on the search terms to identify a search pattern associated with the content.

4. The computer-implemented method of claim 1, wherein the action is a query comprising search terms, and further comprising identifying a search result based on the search terms, wherein the search result identifies the location of the content.

5. The computer-implemented method of claim 1, wherein the content is associated with a web site.

6. The computer-implemented method of claim 1, wherein modifying the content further comprises developing new content based on the aggregated data.

7. The computer-implemented method of claim 1, wherein:
the feedback comprises a rating, and
the level of customer satisfaction is determined from the rating.

8. The computer-implemented method of claim 1, wherein:
the feedback comprises a comment, and
the comment indicates reasons for the level of customer satisfaction.

9. The computer-implemented method of claim 1, wherein the aggregated data:
indicates how often the content was accessed over a period of time, and
compiles the feedback associated with the content over a period of time.

10. The computer-implemented method of claim 1, further comprising prioritizing the content based on the aggregated data, wherein the content that is associated with a low level of user satisfaction is given a high priority.

11. A system for dynamically developing content, comprising:
a client that is arranged to initiate an action to access content;
a server coupled to the client, wherein the server is arranged to:
locate the content based on the action,
provide the content to the client, and
receive feedback associated with the content from the client, wherein the feedback indicates a level of user satisfaction associated with the content;
a data store coupled to the server, wherein the data store is arranged to aggregate data based on at least one of: the action, the feedback, and the content, and further wherein the aggregated data indicates how the content may be modified to increase the level of user satisfaction associated with the content; and
a content management system coupled to the data store, wherein the content management system is arranged to:
modify the content in response to input from a content author based on the aggregated data, and
post the modified content.

12. The system of claim 11, wherein the server is further arranged to:
execute the action;
determine a location on the client from which the action was submitted, and
aggregate the data based on the location to identify a usage pattern associated with the client.

13. The system of claim 11, wherein the server is further arranged to:
execute the action, wherein the action is a query comprising search terms, and
aggregate the data based on the search terms to identify a search pattern associated with the content.

14. The system of claim 11, wherein the server is further arranged to:
execute the action, wherein the action is a query comprising search terms, and
identify a search result based on the search terms, wherein the search result identifies the location of the content.

15. The system of claim 11, wherein the content management system is further arranged to modify the content by developing new content in response to input from the content author based on the aggregated data.

16. The system of claim 11, wherein:
the feedback includes a rating, and
the level of customer satisfaction is determined from the rating.

17. The system of claim 11, wherein:
the feedback includes a comment, and
the level of customer satisfaction is determined from the comment.

18. A computer-readable medium having computer-executable instructions for dynamically developing content, comprising:
locating the content based on an action to access the content;
receiving at least one of: a rating and a comment associated with the content, wherein the rating indicates a level of user satisfaction associated with the content, and the comment indicates reasons for the level of customer satisfaction;
aggregating data based on at least one of: the action, the rating, the comment, and the content, wherein the aggregated data indicates how the content may be modified to increase the level of user satisfaction associated with the content;
modifying the content based on the aggregated data; and
posting the modified content.

19. The computer-readable medium of claim 18, further comprising determining a location from which the action was submitted, and wherein aggregating data further comprises aggregating data based on the location to identify a usage pattern associated with the content.

20. The computer-readable medium of claim 18, wherein the action is a query comprising search term, and wherein aggregating data further comprises aggregating data based on the search terms to identify a search pattern associated with the content.
